(19) United States
(12) Patent Application Publication
(10) Pub. No.: US 2026/0173223 A1
(43) Pub. Date: Jun. 18, 2026

(54) TEMPERATURE-CONTROL-ASSISTED STEAM FUNCTION ON INDUCTION COOKTOPS AND OVER-TEMPERATURE PREVENTION IN COOKTOPS

(71) Applicant: WHIRLPOOL CORPORATION, BENTON HARBOR, MI (US)

(72) Inventors: Andrea Gallivanoni, Casorate Sempione (IT); Andrea Gasparoni, Comerio (IT); Alessandro Gigante, Varese (IT); Daniele Masi, Travedona Monate (IT); Gian Mauro Musso, Portogruaro (IT); Annalisa Pacioni, Bresso (IT); Collin A. Stipe, West Unity, OH (US)

(73) Assignee: WHIRLPOOL CORPORATION, BENTON HARBOR, MI (US)

(21) Appl. No.: 18/982,761

(22) Filed: Dec. 16, 2024

(51) Int. Cl. H05B 6/06; H05B 6/12

(52) U.S. Cl. CPC H05B 6/062; H05B 6/1209; H05B 2213/04; H05B 2213/07

(57) ABSTRACT

A cooktop including: a heating element positioned to increase the temperature of a cooking vessel placed over the heating element; and a controller in communication with the heating element and a human-machine interface, the controller configured (a) to determine a temperature of the cooking vessel, or change thereof, as a function of time and (b) to determine, as a function of at least the determined temperature of the cooking vessel, or change thereof, as a function of time (i) that a food item that was within the cooking vessel is no longer within the cooking vessel or (ii) that liquid originally within the food item or within the cooking vessel generally has escaped therefrom and (b), as a consequence of (a), to perform a remedial action.

### BACKGROUND

Many millions of metric tons of rice are consumed per year throughout the world. Much of the rice is cooked residentially. During the cooking of rice, water penetrates the rice grains. As the hydrated rice grains increase in temperature and continue to absorb water, starches in the rice undergo gelatinization and proteins therein change as well. The result is the rice grains becoming sticky and tender.

There are small appliances, typically called rice cookers, dedicated to the cooking of rice. The rice cookers automatically perform the cooking of the rice. The user measures the rice, adds the rice to the rice cooker, measures a requisite volume of water, and adds the volume of water to the rice cooker as well. The rice cooker typically automatically performs the cooking of the rice by monitoring the temperature within the rice cooker via a temperature sensor. An initial temperature rise is noticed as the water hydrates the rice grains. The water then begins to boil, which the rice cooker notices as a function of temperature. The rice cooker then reduces heat input to allow steam generated from the boiling of the water to further cook the rice. After a period of time, the rice cooker ceases heat input or maintains a low level of heat input to keep the rice warm. Some rice cookers are less sophisticated and do not measure temperature and rely on calculated cooking times (for heat up to boil and then steam) as a function of the amount of rice and water added.

Despite the existence of the rice cooker, consumers would appreciate being able to cook rice with a cooktop, which would avoid the need for a rice cooker and thus free counter space. During a cooking operation of rice (or any other food item) within a cooking vessel upon a cooktop, several events can happen. First, the food item (e.g., rice, steak, and so on) within the cooking vessel can become disassociated from the cooking vessel. For example, the rice can be removed from the vessel as being plated and ready to serve. Second, if the cooking vessel included only liquid (e.g., water), such as in preparation to receive uncooked rice, then all the water could have evaporated. Third, if the cooking vessel included food items with a high content of liquid (e.g., water), then the liquid (e.g., water) could have entirely escaped the food items. All three events can cause undesirable consequences, such as unnecessary energy expenditure by the cooktop, damage to the cooking vessel, or burning of the food items.

However, there is a problem in that the cooktop does not warn the user that those events are occurring. That is a problem because, had the cooktop warned the user, the user could have prevented the events from occurring through to completion.

### SUMMARY

The present disclosure addresses that problem with a cooktop that recognizes, based on determining the temperature of the cooking vessel as a function of time, either that a food item that was within the cooking vessel is no longer within the cooking vessel or that liquid (e.g., water) within the food item or within the cooking vessel has escaped (e.g., boiled away from). As a result, the cooktop notifies the user and/or depowers a heating element of the cooktop. Further, because the cooktop recognizes that liquid (e.g., water) within the food item or within the cooking vessel has boiled away, the cooktop can automatically perform steam cooking operations of food items such as rice, avoiding the need for a separate steam cooking appliance.

According to one aspect of the present disclosure, a cooktop comprises: a heating element positioned to increase the temperature of a cooking vessel placed over the heating element; and a controller in communication with the heating element and a human-machine interface, the controller configured (a) to determine a temperature of the cooking vessel, or change thereof, as a function of time and (b) to determine, as a function of at least the determined temperature of the cooking vessel, or change thereof, as a function of time (i) that a food item that was within the cooking vessel is no longer within the cooking vessel or (ii) that liquid within the food item or within the cooking vessel has escaped the food item or the cooking vessel and (b), as a consequence of (a), to perform a remedial action.

According to another aspect of the present disclosure, a cooktop comprises: a substrate presenting a primary surface positioned to accept a cooking vessel; an induction coil disposed beneath the substrate; and a controller in communication with the induction coil and a human-machine interface, the controller configured (a) to accept a command from a user at the human-machine interface to initiate a steam cooking operation of a food item within the cooking vessel, (b) thereafter, (i) to determine the temperature of the cooking vessel, or change thereof, as a function of time, (ii) to control the induction coil as necessary to achieve and then to maintain the temperature of the cooking vessel at a treatment temperature as a function of the determined temperature of the cooking vessel as a function of time, (iii) to calculate a rate of change of the temperature of the cooking vessel as a function of time, and (iv) to deactivate the induction coil when the rate of change of the temperature of the cooking vessel as a function of time exceeds a predetermined value.

These and other features, advantages, and objects of the present disclosure will be further understood and appreciated by those skilled in the art by reference to the following specification, claims, and appended drawings.

### BRIEF DESCRIPTION OF THE DRAWINGS

In the Drawings:

FIG. 1 is a perspective view of a cooktop of the present disclosure, illustrating a substrate with a human-machine interface providing a notification to the user regarding the status of a steam cooking operation;

FIG. 2 is an exploded view of the cooktop of FIG. 1, illustrating heating elements disposed below the substrate and temperature sensors associated with each of the heating elements;

FIG. 3 is a cross-sectional view of the cooktop of FIG. 1 during a steam cooking operation, illustrating a food item and liquid (e.g., water) within a cooking vessel disposed on a first primary surface of the substrate above one or more heating elements and the temperature sensor positioned to generate output indicative of the temperature of the cooking vessel during the steam cooking operation;

FIG. 4 is a schematic diagram of the cooktop of FIG. 1, illustrating the cooktop further including a controller in communication with the temperature sensor, the human-machine interface, the heating element, and optionally a mobile electronic device providing the human-machine interface; and

FIG. 5 is a graph plotting temperature of the cooking vessel as a function of time for two hypothetical steam cooking experiences, each including a heating period, a treatment period, and a sharp rising period, the last of which indicating either that the food item is no longer present in the cooking vessel or that water initially associated with the food item has boiled away.

The components in the figures are not necessarily to scale, emphasis instead being placed upon illustrating the principles described herein.

### DETAILED DESCRIPTION

The present illustrated embodiments reside primarily in combinations of method steps and apparatus components related to a cooktop. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

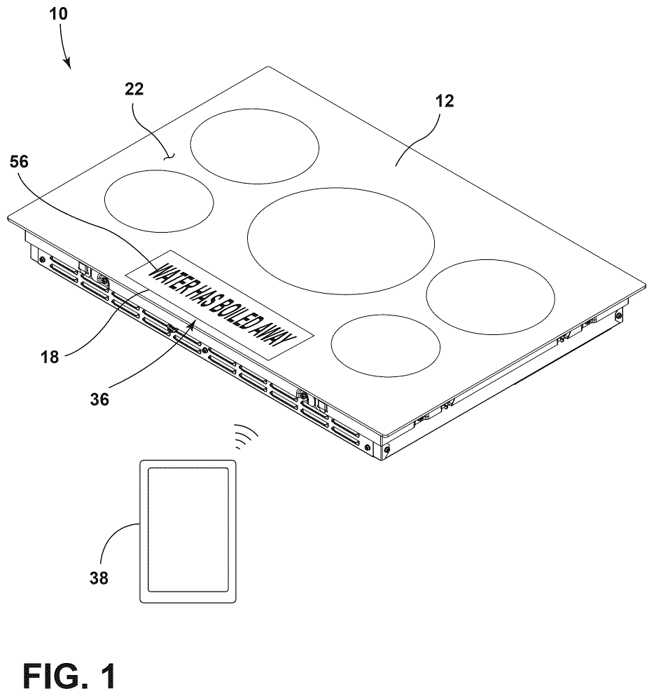

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

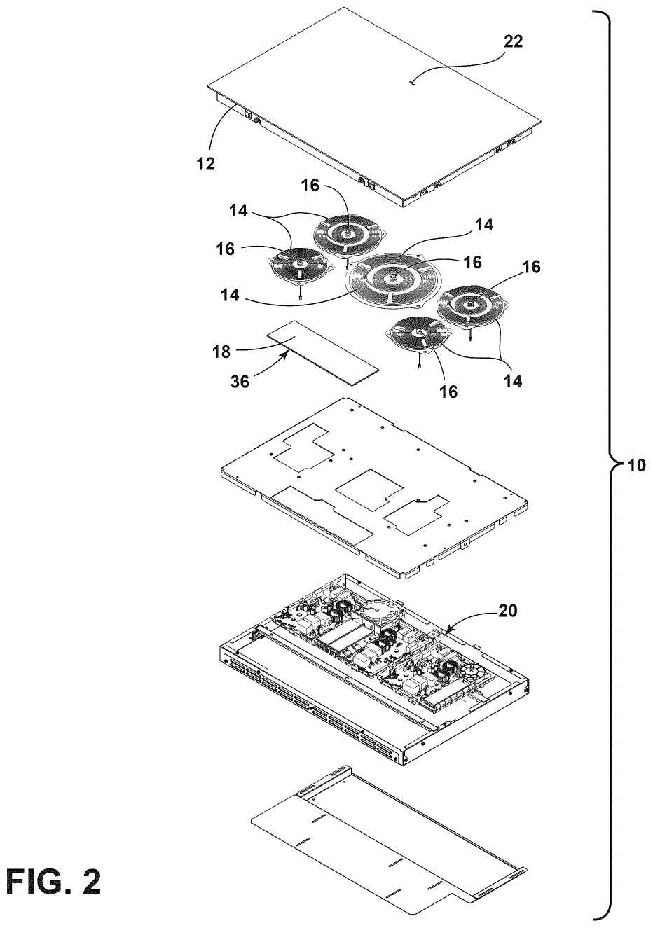

Referring to FIGS. 1-3, a cooktop 10 is herein disclosed. The cooktop 10 includes a substrate 12, a heating element 14, a temperature sensor 16, a human-machine interface 18, and a controller 20. The substrate 12 presents a first primary surface 22 and a second primary surface 24. The first primary surface 22 and the second primary surface 24 can both be planar and parallel to each other. The first primary surface 22 is positioned to accept a cooking vessel 26. For example, the first primary surface 22 can face upward 28 while the second primary surface 24 faces downward 30. The substrate 12 can have a glass composition, a glass-ceramic composition, a ceramic composition, among other options. In use, the substrate 12 accepts the cooking vessel 26 for heat treatment (e.g., a cooking operation) of a food item 32 disposed within the cooking vessel 26.

The heating element 14 can be any heating element 14 that can cause an increase in temperature of the cooking vessel 26. The heating element 14 can be disposed downward 30 relative to the substrate 12 (e.g., beneath the substrate 12) facing the second primary surface 24 of the substrate 12. In other instances, the heating element 14 can extend through the substrate 12 and be exposed to an external environment 34 such that the cooking vessel 26 is disposed directly upon the heating element 14. In embodiments, the heating element 14 is an induction coil. The induction coil can increase the temperature of the cooking vessel 26 when the cooking vessel 26 has suitable material for the induction coil to induce eddy currents therewithin. The material of the cooking vessel 26 resists the eddy currents, and the resistance increases the temperature of the cooking vessel 26.

The temperature sensor 16 generates output indicative of a temperature of the cooking vessel 26 placed over the heating element 14. The closer the temperature sensor 16 is positioned to where the cooking vessel 26 is to be positioned over the heating element 14, the more the output that the temperature sensor 16 generates is indicative of the temperature of the cooking vessel 26. For example, such as when the heating element 14 is an induction coil, the temperature sensor 16 is disposed under the substrate 12 proximate where the substrate 12 is to accept the cooking vessel 26 for the heat treatment of the food item 32. In embodiments, the temperature sensor 16 is a thermistor, although other types of temperature sensors are envisioned. With a thermistor, the output is resistance, which changes as a function of temperature.

In embodiments, the human-machine interface 18 is a component of the cooktop 10. For example, the human-machine interface 18 can be or include a touch-screen display 36 accessible from the external environment 34 at the substrate 12. In other instances, the human-machine interface 18 is or further includes a mobile electronic device 38 (e.g., of the user of the cooktop 10) that is in communication with the cooktop 10. The mobile electronic device 38 in such instances provides the touch-screen display 36. Various additional aspects of the human-machine interface 18 are discussed below.

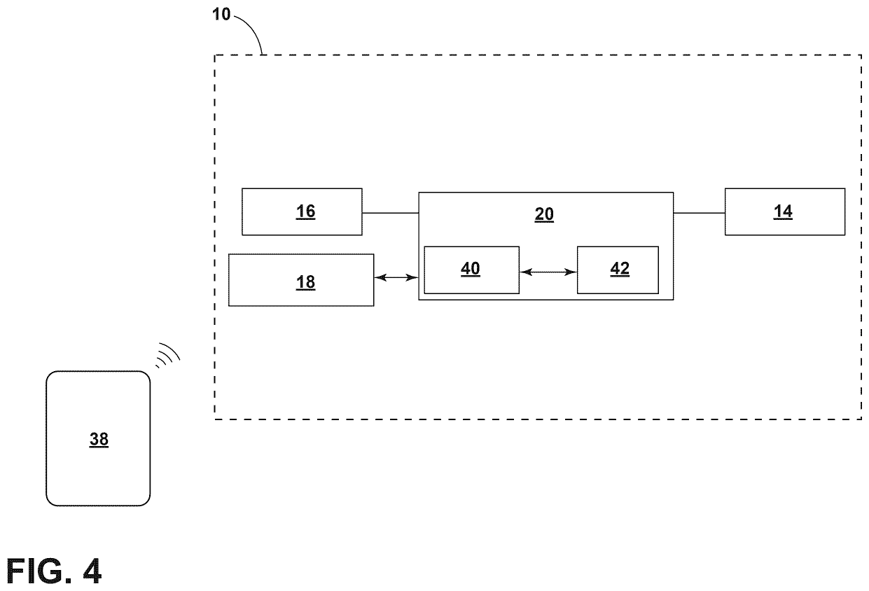

Referring now to FIG. 4, the controller 20 is in communication with the heating element 14, the temperature sensor 16, and the human-machine interface 18. The controller 20 includes a processor 40 and memory 42. The memory 42 stores executable control software that the processor 40 executes in furtherance of the capabilities of the controller 20 further described herein. The memory 42 can be, without limitation, read-only memory (ROM), random-access memory (RAM), keep-alive memory (KAM), PROM (programmable read-only memory), EPROM (electrically PROM), EEPROM (electrically erasable PROM), flash memory, or any other electric, magnetic, optical, or combination memory device capable of storing data, some of which represent executable instructions, used by the controller 20 in controlling the cooktop 10. The processor 40 can be a microprocessor or a central processing unit, among other options. The controller 20 can be in communication with a communications device of the cooktop 10 to communicate both ways with the mobile electronic device 38.

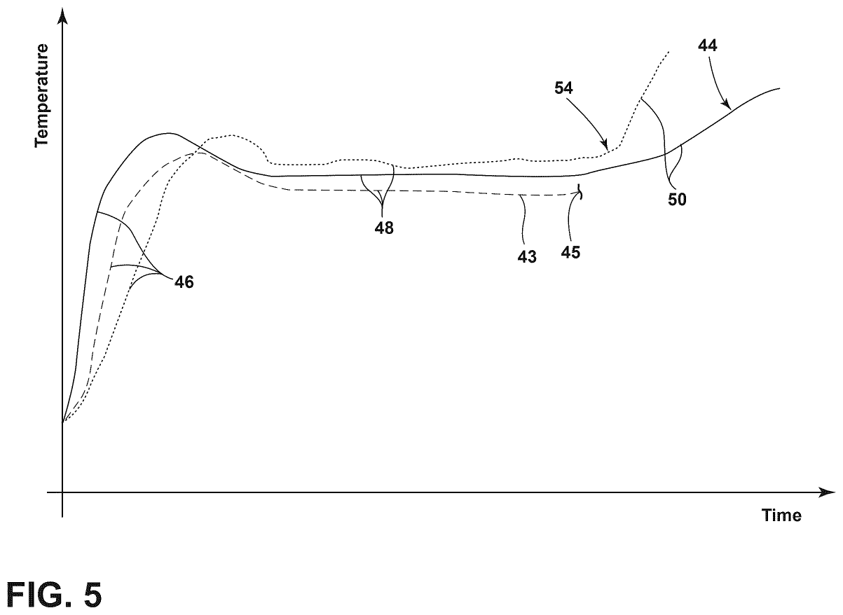

Referring now to FIG. 5, in embodiments, the controller 20 is configured to determine the temperature of the cooking vessel 26, or change thereof, as a function of time. In some instances, the controller 20 can determine the temperature of the cooking vessel 26 as a function of time, at least based in part, on the output received from the temperature sensor 16. However, the controller can rely upon other information in addition to, or as an alternative to, the temperature sensor 16 to determine the temperature of the cooking vessel 26, or change thereof, as a function of time. For example, when the heating element 14 is an induction coil, the controller 20 can determine the temperature of the cooking vessel 26 as a function of time, at least in part, by determining a measurable electrical parameter, such as one related to the induction coil and/or the cooking vessel 26 as a function of time. In that regard, the following equation can be utilized:

$$( {T}_{cv} - {T}_{initial} ) ∝ ( {M}_{cvic} - {M}_{initial} )$$

where T_{cv} is the determined temperature of the cooking vessel 26 at a particular point in time, M_{cvic} is a measurable electrical parameter related to the cooking vessel 26 and the induction coil at the particular point in time, Mᵢₙᵢₜᵢₐₗ is the measurable electrical parameter related to cooking vessel 26 and the induction coil at a previous point in time, and Tᵢₙᵢₜᵢₐₗ is the temperature of the cooking vessel 26 at the previous point in time. While that relationship can be utilized, temperature changes as a function of time can be estimated based on changes in the measurable electrical parameter without having to know Tᵢₙᵢₜᵢₐₗ as follows:

$${T}_{cv}^{′} ∝ {M}_{cvic}^{′}$$

where

$${T}_{cv}^{′} and {M}_{cvic}^{′}$$

are the changes in temperature and the measurable electrical parameter over a period of time (e.g., derivatives). The measurable electrical parameter M can be resistance or inductance (e.g., of the induction coil and the associated cooking vessel 26), among other options.

In normal operation of the cooktop 10, the temperature of the cooking vessel 26 as a function of time has a characteristic signature 43. The temperature of the cooking vessel 26 as a function of time, as determined by the controller 20, includes a heating period 46 where the temperature of the cooking vessel 26 increases to about a set point temperature corresponding to a setting provided at the human-machine interface 18 for the heating element 14. During the heating period 46, the temperature of the cooking vessel 26 rises as a function of time. The temperature of the cooking vessel 26 then levels out at about the set point temperature and stays there for the duration of a treatment period 48. During the treatment period 48, the food item 32 within the cooking vessel 26 is cooked until the user or the cooktop 10 concludes that the heat treatment of the food item 32 has been sufficient. The food item 32 is properly cooked. The user or the cooktop 10 then deactivates the heating element 14, such as at point 45.

However, cooking of the food item 32 does not always go as intended. For example, the user might remove the food item 32 from the cooking vessel 26 and fail to deactivate the heating element 14. Alternatively, liquid (e.g., water) originally within the food item 32 or the cooking vessel 26 generally might have escaped the food item 32 and the cooking vessel 26. For example, the liquid might have boiled away and the food item 32 has dried out. In either scenario, the temperature of the cooking vessel 26 as determined by the controller 20, or change thereof, will show a sharp rising period 50 where the temperature rises sharply as a function of time. The controller 20 can not only determine that the sharp rising period 50 is occurring and perform a remedial action, the controller 20 can distinguish the user having removed the food item 32 from the cooking vessel 26 from the water originally within the food item 32 or the cooking vessel 26 generally having escaped the food item 32 and the cooking vessel 26. The controller 20 can so distinguish those events from each other based on the profile of the determined temperature of the cooking vessel 26, or change thereof, as a function of time, such as at the sharp rising period 50 (but also possibly the heating period 46 and the treatment period 48). With the controller 20 being able to distinguish between those aforementioned scenarios, the controller 20 can perform the remedial action, which may be tailored to each of the different scenarios.

Removal of Food Item 32. In embodiments, the controller 20 is configured to determine, as a function of at least the determined temperature of the cooking vessel 26, or change thereof, as a function of time, that the food item 32 that was within the cooking vessel 26 is no longer within the cooking vessel 26. The controller 20 determines that the food item 32 that was within the cooking vessel 26 for the heat treatment of the food item 32 is no longer within the cooking vessel 26 by comparing the determined temperature of the cooking vessel 26, or change thereof, as a function of time to a first predetermined temperature-as-a-function-of-time signature 44. As illustrated in FIG. 5, and as mentioned above, the temperature of the cooking vessel 26 as a function of time during the heat treatment can include the heating period 46 where the temperature increases to about a set point temperature corresponding to a setting provided at the human-machine interface 18 for the heating element 14. The temperature as a function of time after the heating period 46 thereafter can include the treatment period 48 of a relatively constant temperature for a period of time. The temperature as a function of time after the treatment period 48 can then further include the sharp rising period 50 where the temperature rises sharply as a function of time. The first predetermined temperature-as-a-function-of-time signature 44 includes the treatment period 48 (where temperature is relatively constant for a period of time) followed by the sharp rising period 50 (where temperature rises sharply). The controller 20 can determine based on the sharp rising period 50 that the cooking operation is not proceeding as intended. Further, the controller 20 can determine, based on comparing the determined temperature of the cooking vessel 26, or change thereof, as a function of time to the first predetermined temperature-as-a-function of time signature 44 (including but not limited to the sharp rising period 50) that the particular scenario is that the food item 32 was originally within the cooking vessel 26 but then was no longer being within the cooking vessel 26. In short, the first predetermined temperature-as-a-function-of-time signature 44 is indicative of the food item 32 first being within the cooking vessel 26 and then consequently no longer being within the cooking vessel 26. As a result, the temperature of the cooking vessel 26 rises sharply, thus providing the sharp rising period 50 of the first predetermined temperature-as-a-function-of-time signature 44. The sharp rise in temperature (e.g., the sharp rising period 50) is not associated with an increase in thermal output of the heating element 14. Rather, the heating element 14 is generating the same thermal output during the sharp rising period 50 as the heating element 14 did during the treatment period 48 where temperature as a function of time was relatively constant. However, the food item 32 is no longer present within the cooking vessel 26 and thus the cooking vessel 26 rather than the food item 32 absorbs the thermal output of the heating element 14 leading to the sharp rising period 50. While the food item 32 is within the cooking vessel 26, the food item 32 absorbs thermal output from the heating element 14, which results in the treatment period 48. After the food item 32 is removed, the food item 32 can no longer absorb thermal output from the heating element 14. The first predetermined temperature-as-a-function-of-time signature 44 can be developed via machine learning or statistical analysis. The determined temperature of the cooking vessel 26, or change thereof, as a function of time then largely matches or corresponds to the first predetermined temperature-as-a-function-of-time signature 44, including at the sharp rising period 50.

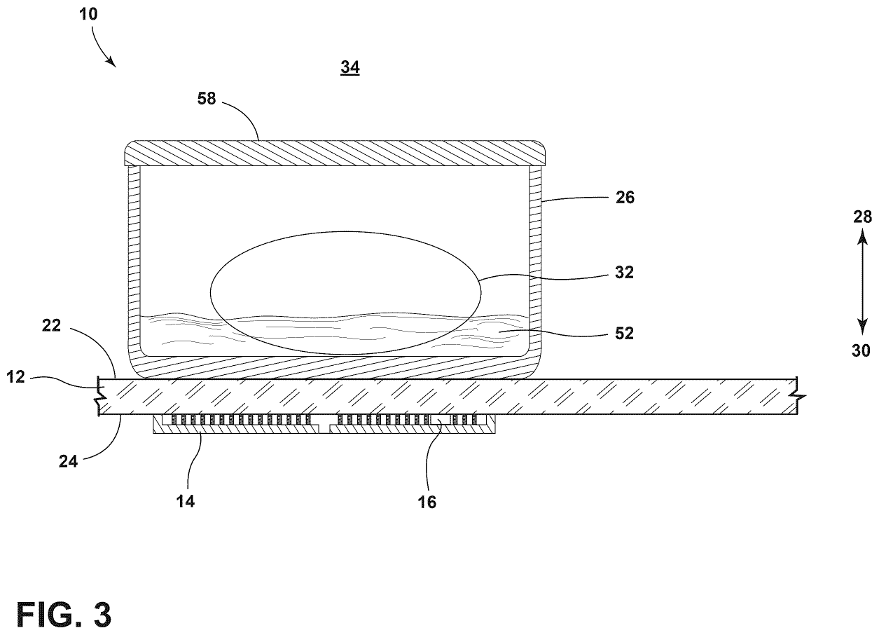

Escape of Water Originally Within the Food Item 32 or the Cooking Vessel 26. In embodiments, the controller 20 is configured to determine, as a function of the determined temperature of the cooking vessel 26, or change thereof, as a function of time, that liquid 52 (e.g., water) (see FIG. 3) originally within food item 32 or the cooking vessel 26 generally has escaped the food item 32 and/or the cooking vessel 26 (e.g., the food item 32 has dried out or the liquid 52 within the cooking vessel 26 has boiled away). The controller 20 can determine that the liquid 52 originally within the food item 32 or within the cooking vessel 26 generally has escaped therefrom 26 by comparing the determined temperature of the cooking vessel 26, or change thereof, as a function of time to a second predetermined temperature-as-a-function-of-time signature 54. As with the scenario where the food item 32 was removed from the cooking vessel 26, with this scenario the determined temperature (or change thereof) as a function of time will show the heating period 46, the treatment period 48, and the sharp rising period 50. In instances when the food item 32 or the cooking vessel 26 generally initially includes a significant amount of liquid 52, the temperature during the treatment period 48 will be a relatively constant temperature of about 100° C. followed by the sharp rising period 50. The second predetermined temperature-as-a-function-of-time signature 54 is characteristic of such a scenario. The controller 20 compares the determined temperature (or change thereof) as a function of time to the second predetermined temperature-as-a-function-of-time signature 54 and determines that it sufficiently matches the second predetermined temperature-as-a-function-of-time signature 54, including but not limited to at the sharp rising period 50. The treatment periods 48 of the first predetermined temperature-as-a-function-of-time signature 44 and the second predetermined temperature-as-a-function-of-time signature 54 are different, because the presence of significant amount of liquid 52 originally within the food item 32 or the cooking vessel 26 generally for the latter results in the treatment period 48 occurring at about 100° C. while the former is not so constrained. The sharp rising periods 50 of the first predetermined temperature-as-a-function-of-time signature 44 and the second predetermined temperature-as-a-function-of-time signature 54 are different, because the food item 32 is still within the cooking vessel 26 for the latter and thus can still absorb thermal output of the heating element 14. The second predetermined temperature-as-a-function-of-time signature 54 can be made with the assistance of machine learning and statistical analysis. The second predetermined temperature-as-a-function-of-time signature 54 is indicative of the liquid 52 initially within the food item 32 or the cooking vessel 26 generally having escaped therefrom (e.g., boiled away). As an example, while the food item 32 is within the cooking vessel 26, the liquid 52 originally within the food item 32 absorbs thermal output from the heating element 14 at a relatively constant temperature, which results in the treatment period 48. After the liquid 52 has escaped from the food item 32, the liquid 52 can no longer absorb thermal output from the heating element 14 and only the remaining mass of the food item 32 can. As a result, the temperature of the cooking vessel 26 rises sharply, thus providing the sharp rising period 50 of the second predetermined temperature-as-a-function-of-time signature 54. The sharp rise in temperature (e.g., the sharp rising period 50) is not associated with an increase in thermal output of the heating element 14. Rather, the heating element 14 is generating the same thermal output during the sharp rising period 50 as the heating element 14 did during the treatment period 48 where temperature as a function of time was relatively constant. However, the liquid 52 is no longer present within the food item 32 and cooking vessel 26, rather than the liquid 52, absorbs the thermal output of the heating element 14 leading to the sharp rising period 50. The same concept applies for instances where the cooking vessel 26 originally includes a content of the liquid 52. After the liquid 52 has escaped from the cooking vessel 26, the liquid 52 can no longer absorb thermal output from the heating element 14, and the temperature of the cooking vessel 26 rises sharply.

The controller 20 can determine that the determined temperature of the cooking vessel 26, or change thereof, as a function of time aligns more with the first predetermined temperature-as-a-function-of-time signature 44 than the second predetermined temperature-as-a-function-of-time signature 54, or vice versa, and take a remedial action that is tailored for the particular scenario. Again, machine learning or statistical analysis can be utilized to identify and characterize those differences.

Remedial Action. As a consequence of the controller 20 determining, as a function of the determined temperature of the cooking vessel 26 (or change thereof) as a function of time, either (i) that the food item 32 that was within the cooking vessel 26 is no longer within the cooking vessel 26 or (ii) that liquid 52 originally within the food item 32 or within the cooking vessel 26 generally has escaped therefrom, the controller 20 is further configured to perform a remedial action. The remedial action can be the controller 20 causing the human-machine interface 18 to issue a notification 56 (see FIG. 1) to the user. The notification 56 can be indicative of either (i) that the food item 32 that was within the cooking vessel 26 is no longer within the cooking vessel 26 or (ii) that liquid 52 originally within the food item 32 or within the cooking vessel 26 generally has escaped therefrom, as the case may be. The notification 56 can be audible (e.g., “liquid has boiled away”) or visual (e.g., “liquid has boiled away” or a graphical icon of such). The notification 56 can be delivered at the cooktop 10. The notification 56 can be delivered at the mobile electronic device 38.

Alternatively or additionally, the remedial action can be or include reducing power output of the heating element 14. Reducing the power output includes deactivating the heating element 14. Reducing power output of the heating element 14 allows the temperature of the cooking vessel 26 to decrease toward ambient temperature and prevents the sharp rising period 50 from continuing.

Automatic performance. In embodiments, the cooktop 10 automatically performs a steam cooking operation. In such embodiments, the controller 20 is configured to accept a command from the user at the human-machine interface 18 to initiate a steam cooking operation. For example, at the touch-screen display 36, the user can select “steam cook rice” and the controller 20, being in communication with the touch-screen display 36 (as the human-machine interface 18), recognizes the output from the touch-screen display 36 as indicative of the user desiring the cooktop 10 to perform a steam cooking operation on rice as the food item 32.

Assuming that the user has placed the food item 32 and water 52 within the cooking vessel 26 and has placed the cooking vessel 26 (so occupied) upon the substrate 12 above the heating element 14, the controller 20 is further configured to control the heating element 14 (e.g., the induction coil) as necessary to achieve and then to maintain the temperature at a treatment temperature as a function of the determined temperature of the cooking vessel 26. The controller 20 activates the heating element 14 to achieve a temperature within the cooking vessel 26 of greater than 100° C. (e.g., about 120° C.). The controller 20 recognizes the heating period 46, where the temperature rises as a function of time, and subsequently recognizes the treatment period 48, where the temperature is substantially constant as a function of time. The steam cooking thermal treatment is performed during at least the treatment period 48.

During at least the treatment period 48, the controller 20 is further configured to calculate a rate of change of the temperature of the cooking vessel 26. The rate of change of the temperature is the temperature change divided by the time period of the temperature change. The rate of change can be the first derivative of temperature as a function of time, and can be visualized as a slope at FIG. 5. The controller 20 can quantify the acceleration of temperature based at least in part on output received from the temperature sensor 16. In addition or in the alternative, the controller 20 can determine the range of change of the temperature of the cooking vessel 26 by determining the change in a measurable electrical parameter, as explained above, such as the inductance of the cooking vessel 26 and the induction coil (as the heating element 14) over the period of time.

The controller 20 is further configured to deactivate the heating element 14 (e.g., the induction coil) when the rate of change of the temperature exceeds a predetermined value. In short, the controller 20 is configured to identify the sharp rising period 50 indicative of the liquid 52 escaping from the food items 32 and the cooking vessel 26 generally and then deactivates the heating element 14 as a result. The sharp rising period 50 being so recognized indicates the functional end of the steam cooking operation, because there is insufficient liquid 52 remaining in the cooking vessel 26 to phase change effectively into steam.

The controller 20 can be further configured (i) to query the user as to a name and quantity of the food being subjected to the steam cooking operation, (ii) to calculate a volume of liquid 52 (e.g., water) needed to perform the steam cooking operation as a function of the name and the quantity of the food, and (iii) to issue a notification 56 to the user of the volume of the liquid 52 to add to the cooking vessel 26 for performance of the steam cooking operation. The query, calculation, and issuance of the notification 56 occurs after or along with acceptance of the command from the user to initiate the steam cooking operation. Querying the user as to the name and quantity of the food to be subjected to the steam cooking operation occurs at the human-machine interface 18. An example is a selectable list is presented at the touch-screen display 36 and the user selects the food item 32 (e.g., rice) and then is prompted to input a quantity (e.g., 2 cups). The controller 20 receives the input and then can calculate the volume of water 52 needed (e.g., 2 cups of water 52). The controller 20 then causes the human-machine interface 18 to issue the notification 56 to the user of the volume (e.g., “please deposit two cups water”). The user can then confirm that the water 52 has been deposited at the human-machine interface 18.

The controller 20 can be further configured to (i) determine a period of time for the steam cooking operation as a function of the name and quantity of the food item 32 being subjected to the steam cooking operation and (ii) issue a notification 56 to the user of the period of time. Having received the name and the quantity of the food item 32 from the human-machine interface 18 and the quantified volume of water 52 to be utilized, the controller 20 can determine the period of time for the steam cooking operation. The period of time for the steam cooking operation can be determined from look up tables or equations stored in the memory 42. The notification 56 is issued at the human-machine interface 18 (e.g., a visual countdown clock).

The cooktop 10 of the present disclosure addresses the problems expressed in the Background, and other problems, in a variety of ways. Among them, the controller 20 being configured to implement remedial action after recognizing that the sharp rising period 50 is occurring (indicating that the food item 32 is no longer within the cooking vessel 26 or that the liquid 52 originally within the food item 32 or the cooking vessel 26 generally has escaped therefrom) prevents unnecessary energy expenditure by the cooktop 10, damage to the cooking vessel 26, and burning of the food items 32. Because of the remedial action, the sharp rising period 50 does not occur for a time period sufficient for such suboptimal events to occur. The user either depowers the heating element 14 or the controller 20 does so if the user does not.

In addition, the cooktop 10 can perform a steam cooking operation, such as the cooking of rice. The user no longer needs a separate steam cooking appliance, such as a rice cooker. The user thus has more counter space. The user need not lift a lid 58 of the cooking vessel 26 to monitor the status of the food item 32 (e.g., rice) during the cooking operation. The controller 20 monitoring the temperature as a function of time for the sharp rising period 50 allows the controller 20 to understand when the steam cooking operation has been fulfilled and then issue the notification 56 to the user and/or depower the heating element 14. The controller 20 calculating the rate of change of the temperature of the cooking vessel 26 crossing the predetermined rate of change indicates that there is no longer liquid 52 within the cooking vessel 26. The depowering of the heating element 14 prevents overcooking of the food item 32 (e.g., rice).

According to a first aspect of the present disclosure, a cooktop comprises: a heating element positioned to increase the temperature of a cooking vessel placed over the heating element; and a controller in communication with the heating element and a human-machine interface, the controller configured (a) to determine a temperature of the cooking vessel, or change thereof, as a function of time and (b) to determine, as a function of at least the determined temperature of the cooking vessel, or change thereof, as a function of time (i) that a food item that was within the cooking vessel is no longer within the cooking vessel or (ii) that liquid originally within the food item or within the cooking vessel has escaped the food item or the cooking vessel and (b), as a consequence of (a), to perform a remedial action.

According to a second aspect of the present disclosure, the cooktop of the first aspect is presented, wherein (i) the heating element is an induction coil, and (ii) the controller is configured to determine the temperature of the cooking vessel, or change thereof, as a function of time, at least in part, by determining a change in a measurable electrical parameter.

According to a third aspect of the present disclosure, the cooktop of the second aspect is presented, wherein the measurable electrical parameter is one or more of (i) an inductance of the induction coil and the associated cooking vessel and (ii) a resistance.

According to a fourth aspect of the present disclosure, the cooktop of any one of the first through third aspects further comprises: a temperature sensor that generates output indicative of the temperature of the cooking vessel, wherein, controller is further configured to determine the temperature of the cooking vessel, or change thereof, as a function of time at least in part as a function of the output received from the temperature sensor.

According to a fifth aspect of the present disclosure, the cooktop of any one of the first through the fourth aspects is presented, wherein the controller is configured to determine, as a function of at least the determined temperature of the cooking vessel, or change thereof, that a food item that was within the cooking vessel is no longer within the cooking vessel.

According to a sixth aspect of the present disclosure, the cooktop of the fifth aspect is presented, wherein the controller determines that the food item that was within the cooking vessel is no longer within the cooking vessel by comparing the determined temperature of the cooking vessel, or change thereof, as a function of time to a first predetermined temperature-as-a-function-of-time signature.

According to a seventh aspect of the present disclosure, the cooktop of the sixth aspect is presented, wherein the determined temperature of the cooking vessel, or change thereof, as a function of time and the first predetermined temperature-as-a-function-of-time signature both include a relatively constant temperature for a period of time followed by a sharp rise in temperature as a function of time.

According to an eighth aspect of the present disclosure, the cooktop of the seventh aspect is presented, wherein the sharp rise in temperature as a function of time is not associated with an increase in thermal output of the heating element.

According to a ninth aspect of the present disclosure, the cooktop of any one of the sixth through eighth aspects is presented, wherein the first predetermined temperature-as-a-function-of-time signature is different than a boil dry temperature-as-a-function-of-time signature indicative of water alone within a cooking vessel having been brought to boil and then boiled entirely away leaving the cooking vessel empty.

According to a tenth aspect of the present disclosure, the cooktop of any one of the first through ninth aspects is presented, wherein the controller is configured to determine, as a function of the determined temperature, or change thereof, of the cooking vessel, that liquid originally within the food item or within the cooking vessel has escaped the food item or the cooking vessel.

According to an eleventh aspect of the present disclosure, the cooktop of the tenth aspect is presented, wherein the controller determines that the liquid originally within the food item or within the cooking vessel has escaped the food item or the cooking vessel by comparing the determined temperature, or change thereof, of the cooking vessel as a function of time to a second predetermined temperature-as-a-function-of-time signature.

According to a twelfth aspect of the present disclosure, the cooktop of the eleventh aspect is presented, wherein the determined temperature of the cooking vessel, or change thereof, as a function of time and the second predetermined temperature-as-a-function-of-time signature both include a period of time at a relatively constant temperature followed by a sharp rise in temperature as a function of time.

According to a thirteenth aspect of the present disclosure, the cooktop of the twelfth aspect is presented, wherein the sharp rise in temperature as a function of time is not associated with an increase in thermal output of the heating element.

According to a fourteenth aspect of the present disclosure, the cooktop of any one of the first through thirteenth aspects is presented, wherein the remedial action comprises causing the human-machine interface to issue a notification to a user indicative (i) that the food item within the cooking vessel has become disassociated from the cooking vessel or (ii) that liquid originally within the food item or the cooking vessel has escaped therefrom.

According to a fifteenth aspect of the present disclosure, the cooktop of any one of the first through fourteenth aspects is presented, wherein the remedial action comprises reducing power output of the heating element.

According to a sixteenth aspect of the present disclosure, a cooktop comprises: a substrate presenting a primary surface positioned to accept a cooking vessel; an induction coil disposed beneath the substrate; and a controller in communication with the induction coil and a human-machine interface, the controller configured (a) to accept a command from a user at the human-machine interface to initiate a steam cooking operation of a food item within the cooking vessel, (b) thereafter, (i) to determine the temperature of the cooking vessel as a function of time, (ii) to control the induction coil as necessary to achieve and then to maintain the temperature of the cooking vessel at a treatment temperature as a function of the determined temperature of the cooking vessel as a function of time, (iii) to calculate a rate of change of the temperature of the cooking vessel, and (iv) to deactivate the induction coil when the rate of change of the temperature of the cooking vessel as a function of time exceeds a predetermined value.

According to a seventeenth aspect of the present disclosure, the cooktop of the sixteenth aspect further comprises: a temperature sensor in communication with the controller, the temperature sensor positioned to generate output indicative of temperature of the cooking vessel placed upon the cooking surface above the induction coil, wherein, the controller determines the temperature of the cooking vessel as a function of time, at least in part, as a function of the output of the temperature sensor.

According to an eighteenth aspect of the present disclosure, the cooktop of any one of the sixteenth through seventeenth aspects is presented, wherein the controller is configured to calculate a rate of change of the temperature of the cooking vessel, at least in part, by determining a change in inductance of the induction coil and the associated cooking vessel.

According to a nineteenth aspect of the present disclosure, the cooktop of any one of the sixteenth through eighteenth aspects is presented, wherein the controller is further configured (i) to query the user as to a name and quantity of the food item being subjected to the steam cooking operation, (ii) to calculate a volume of water needed to perform the steam cooking operation as a function of the name and the quantity of the food item, and (iii) to issue a notification to the user of the volume of the water to add to the cooking vessel for performance of the steam cooking operation.

According to a twentieth aspect of the present disclosure, the cooktop of the nineteenth aspects is presented, wherein the controller is further configured (i) to determine a period of time for the steam cooking operation as a function of the name and quantity of the food item being subjected to the steam cooking operation and (ii) to issue a notification to the user of the period of time.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooktop comprising:
a heating element positioned to increase the temperature of a cooking vessel placed over the heating element; and
a controller in communication with the heating element and a human-machine interface, the controller configured (a) to determine a temperature of the cooking vessel, or change thereof, as a function of time and (b) to determine, as a function of at least the determined temperature of the cooking vessel, or change thereof, as a function of time (i) that a food item that was within the cooking vessel is no longer within the cooking vessel or (ii) that liquid originally within the food item or within the cooking vessel has escaped the food item or the cooking vessel and (b), as a consequence of (a), to perform a remedial action.

2. The cooktop of claim 1, wherein
the heating element is an induction coil, and
the controller is configured to determine the temperature of the cooking vessel, or change thereof, as a function of time, at least in part, by determining a change in a measurable electrical parameter.

3. The cooktop of claim 2, wherein
the measurable electrical parameter is one or more of (i) an inductance of the induction coil and the associated cooking vessel and (ii) a resistance.

4. The cooktop of claim 1 further comprising:
a temperature sensor that generates output indicative of the temperature of the cooking vessel,
wherein, controller is further configured to determine the temperature of the cooking vessel, or change thereof, as a function of time at least in part as a function of the output received from the temperature sensor.

5. The cooktop of claim 1, wherein
the controller is configured to determine, as a function of at least the determined temperature of the cooking vessel, or change thereof, that a food item that was within the cooking vessel is no longer within the cooking vessel.

6. The cooktop of claim 5, wherein
the controller determines that the food item that was within the cooking vessel is no longer within the cooking vessel by comparing the determined temperature of the cooking vessel, or change thereof, as a function of time to a first predetermined temperature-as-a-function-of-time signature.

7. The cooktop of claim 6, wherein
the determined temperature of the cooking vessel, or change thereof, as a function of time and the first predetermined temperature-as-a-function-of-time signature both include a relatively constant temperature for a period of time followed by a sharp rise in temperature as a function of time.

8. The cooktop of claim 7, wherein
the sharp rise in temperature as a function of time is not associated with an increase in thermal output of the heating element.

9. The cooktop of claim 6, wherein
the first predetermined temperature-as-a-function-of-time signature is different than a boil dry temperature-as-a-function-of-time signature indicative of water alone within a cooking vessel having been brought to boil and then boiled entirely away leaving the cooking vessel empty.

10. The cooktop of claim 1, wherein
the controller is configured to determine, as a function of the determined temperature, or change thereof, of the cooking vessel, that liquid originally within the food item or within the cooking vessel has escaped the food item or the cooking vessel.

11. The cooktop of claim 10, wherein
the controller determines that the liquid originally within the food item or within the cooking vessel has escaped the food item or the cooking vessel by comparing the determined temperature, or change thereof, of the cooking vessel as a function of time to a second predetermined temperature-as-a-function-of-time signature.

12. The cooktop of claim 11, wherein
the determined temperature of the cooking vessel, or change thereof, as a function of time and the second predetermined temperature-as-a-function-of-time signature both include a period of time at a relatively constant temperature followed by a sharp rise in temperature as a function of time.

13. The cooktop of claim 12, wherein
the sharp rise in temperature as a function of time is not associated with an increase in thermal output of the heating element.

14. The cooktop of claim 1, wherein
the remedial action comprises causing the human-machine interface to issue a notification to a user indicative (i) that the food item within the cooking vessel has become disassociated from the cooking vessel or (ii) that liquid originally within the food item or the cooking vessel has escaped therefrom.

15. The cooktop of claim 1, wherein
the remedial action comprises reducing power output of the heating element.

16. A cooktop comprising:
a substrate presenting a primary surface positioned to accept a cooking vessel;
an induction coil disposed beneath the substrate; and
a controller in communication with the induction coil and a human-machine interface, the controller configured (a) to accept a command from a user at the human-machine interface to initiate a steam cooking operation of a food item within the cooking vessel, (b) thereafter, (i) to determine the temperature of the cooking vessel as a function of time, (ii) to control the induction coil as necessary to achieve and then to maintain the temperature of the cooking vessel at a treatment temperature as a function of the determined temperature of the cooking vessel as a function of time, (iii) to calculate a rate of change of the temperature of the cooking vessel, and (iv) to deactivate the induction coil when the rate of change of the temperature of the cooking vessel as a function of time exceeds a predetermined value.

17. The cooktop of claim 16 further comprising:
a temperature sensor in communication with the controller, the temperature sensor positioned to generate output indicative of temperature of the cooking vessel placed upon the cooking surface above the induction coil,
wherein, the controller determines the temperature of the cooking vessel as a function of time, at least in part, as a function of the output of the temperature sensor.

18. The cooktop of claim 16, wherein
the controller is configured to calculate a rate of change of the temperature of the cooking vessel, at least in part, by determining a change in an inductance of the induction coil and the associated cooking vessel.

19. The cooktop of claim 16, wherein
the controller is further configured (i) to query the user as to a name and quantity of the food item being subjected to the steam cooking operation, (ii) to calculate a volume of water needed to perform the steam cooking operation as a function of the name and the quantity of the food item, and (iii) to issue a notification to the user of the volume of the water to add to the cooking vessel for performance of the steam cooking operation.

20. The cooktop of claim 19, wherein
the controller is further configured (i) to determine a period of time for the steam cooking operation as a function of the name and quantity of the food item being subjected to the steam cooking operation and (ii) to issue a notification to the user of the period of time.
